(19) United States
(12) Patent Application Publication
(10) Pub. No.: US 2019/0106617 A1
(43) Pub. Date: Apr. 11, 2019

(54) Method and Composition for Drag Reduction and Treatment of Paraffin Deposits in Oil and Gas Infrastructure

(71) Applicant: Steven Glenn Shaw, Judson, TX (US)

(72) Inventor: Steven Glenn Shaw, Judson, TX (US)

(21) Appl. No.: 15/730,680

(22) Filed: Oct. 11, 2017

(51) Int. Cl. C09K 8/524

(52) U.S. Cl. CPC C09K 8/524; F17D 1/17

(57) ABSTRACT

A drag reducing composition and method of use wherein the drag reducing composition comprises a drag reducing surfactant and a solvent mixture that improves flow of fluid by reducing friction losses in a transport conduit while simultaneously cleaning the undesirable wax deposits from the conduit. The drag reducing additives of the invention are not subject to sheer degradation and are substantially useful in reducing drag in hydrocarbon fluids without compromised efficacy downstream from the injection site due to the molecules' ability to self-repair.

### BACKGROUND

Frictional pressure loss in a pipeline system is a costly waste of energy. Consistent conduit fluid properties that minimize frictional pressure loss need to be maintained for efficient operation. Adding compositions to the flowing hydrocarbon that reduce the amount of horsepower required to move volumes of fluid is an extremely powerful tool in crude oil pipeline fluid transportation. The prior art abounds with patents directed to high molecular weight polyolefin polymer compositions that significantly reduce turbulent flow and decrease drag of hydrocarbon streams in crude oil pipelines.

The chemical structure of the most commonly used drag reduction additives in the industry is one of the following polymers or copolymers: low density polyethylene, copolymer of 1-hexane cross linked with vinyl benzene, polyacrylamides, polyalkylmethacrylates and terpolymer of styrene, alkyl acrylate and acrylic acid. These conventional drag reduction additives display flow enhancing characteristics, are generally hydrocarbon soluble, reduce turbulent flow and decrease drag. Common commercially available drag reducing agents are mostly polymer based drag reducing agents and their limitations are frequently and easily recognized.

One serious problem in the effectiveness of polymer drag reducers is the chain degradation of polymers by shear strains in turbulent flow. Ultra-high molecular weight polymers are more susceptible to shear-induced degradation and polymers with linear chain-structure are more vulnerable than branched polymers. The mechanism of shear degradation is assumed to be associated with chain elongation. Chain degradation is often observed when the shear rate is increased to a critical point, after which drag reduction sharply decreases.

It is well-known that these polymer drag reducers degrade by shear when injected in the conduit crude oil stream and cannot reform due to their inability to self-repair which significantly diminishes the polymer's function as it flows in the hydrocarbon stream. These polymer chains break into small segments which cause excessive turbulent movement that decreases the drag reduction agent's effectiveness while increasing the power needed to move the fluid in the conduit. This needed increased in power causes the pumps to apply high sheer stress to move the fluid which results in additional degradation of the polymer ultimately rendering the drag reduction agent ineffective. This increased power needed to pump the fluid through the channel is a costly side effect of the polymer drag reducing agents. Conversely, a sheer stable drag reducing agent that has the ability to self-repair, reduces the amount of power needed to pump the fluid through the channel of the conduit which significantly reduces the cost of using this type of drag reduction agent.

Because a polymer drag reducing agent's effectiveness decreases as it flows down the pipeline due to shear degradation, the agent must be injected at multiple sites along the pipeline. Multiple injection sites increase the overall cost of using a polymer drag reducing agent but are absolutely necessary to maintain this drag reducing agent's effectiveness. Further complicating the multiple injection sites are the fact that the conduit injection points are located in remote and frequently inaccessible locations. Often the remote locations encompass an added element of temperature extremes that also must be addressed. Frigid temperatures complicate the environment in which a drag reducing agent must perform. Any means that reduces the number of injection sites significantly and is effective in frigid temperatures, reduces the cost of using a drag reduction agent.

Polymer drag reduction agents that require multiple injection sites along the conduit to maintain efficacy also frequently require expensive specialized equipment to inject the long chain polymers into the conduit. This specialized injection equipment adds yet another additional cost to operating and maintaining the pipeline. Eliminating the need for multiple injection sites also reduces the need for expensive specialized injection equipment which includes manpower, time to install the equipment, and required maintenance to keep the equipment fully functioning at the injection sites. Selecting a drag reducing agent that requires fewer injection sites is extremely beneficial for cost control.

Additionally, an efficient drag reducing composition should leave no deleterious effects to the flowing hydrocarbon or conduit. Some drag reducing compositions must be separated from the hydrocarbon before the hydrocarbon can be refined which adds a significant cost and processing time delay. Using only drag reducing compositions that do not require removal from the hydrocarbon or further treatment prior to storage, refinery use, or final product is essential in containing costs.

A majority of the current chemicals treatments available in the marketplace fall out before doing their work. Moving away from the industry standard of high molecular weight polymers to using drag reducing agents that are shear stable, significantly increases the drag reduction effectiveness because a shear stable drag reducing agent flows in the conduit without rendering itself ineffective downstream from injection site.

Surfactants are a shear stable class of drag reducing agents that have the ability to self-repair by forming micelles. After degradation of shear, a surfactant repairs itself in a matter of seconds. The ability to self-repair from the effects of degradation clearly distinguishes a surfactant from a polymer which by no means is able to regain its original structure. Because the surfactant can self-repair, the efficacy of the surfactant is not diminished in the flow of the hydrocarbon stream. The mechanisms by which surfactants work are not definitively established but its ability to suppress turbulence, modify wall layers, and reduce friction in a hydrocarbon flowing conduit are well documented.

Surfactants are not known in the industry to be cost competitive drag reduction agents and are frequently used in combination with the more commonly used polymers instead of as a stand-alone drag reduction agent. Many studies and patents in fact discourage the use of surfactants due the additional cost associated with surfactants. Additionally, there is a common belief concerning surfactants that emphasizes that the efficacy of the surfactants alone are inadequate without blending the surfactant with a polymeric drag reducing agent. The present invention dispels many of these beliefs and proves that surfactants without the addition of polymers are extremely powerful and efficient drag reduction agents.

An additional efficacy concern in hydrocarbon flow are the paraffin deposits in the flow line, pipelines, and other related equipment that can reduce the ability of infrastructure to operate efficiently. Hydrocarbon conduit and infrastructure are subject to failure attributed to paraffin and related deposits that increase costs and pipeline flow stream delivery and transportation. These deposits are generally a collecting of crude oil changes in composition due to loss of dissolved gasses as temperature and pressure change in the conduit. The formation of paraffin deposits reduce the inner diameter of the conduit which restricts flow and can ultimately block off the pipeline. This decreased conduit diameter also develops a rough interior surface that increases the pump pressure required to move the hydrocarbon. And more, these deposits can also build up on valves, instrumentation, and other internal conduit infrastructure.

Current injectable paraffin treatment practices require heat, a solvent, or a combination of both to dissolve most paraffin deposits. Heat is the key in using these techniques and not the solvent because the effectiveness of the treatment is dependent on temperature. Heat becomes a limiting treatment factor as the application of heat becomes extremely limited as the inaccessibility of the pipeline location increases in remote locations. These remote locations require significant travel time to reach the location of the pipeline in addition to the expense of getting workers and their necessary equipment to the remote location. Additionally, remote locations often have temperature extremes to address and battle the elements. Any treatment that reduces the dependency on heat to combat paraffin deposits significantly reduces the cost of using a drag reduction agent.

Another current wax deposit treatment practice is to perform line cleaning (pigging) which requires tremendously expensive downtime and timely maintenance. Pigging is a valuable tool in cleaning the pipeline but an exceptionally costly process. The cost limitation of performing line cleaning is further restricted by the ability to clean small hard to reach infrastructure that is not accessible via pig. Agents that reduce the necessity and frequency to perform line cleaning by removing and preventing paraffin deposits without the necessity of heat to activate are preferred and provide a tremendous cost savings.

### SUMMARY

In one aspect, the present invention provides drag reducing compositions that significantly reduce drag and clean paraffin deposits. In another aspect, the present invention provides drag reducing compositions that self-repair to maintain efficacy while simultaneously cleaning and liquefying paraffin deposits in the conduit reducing the need to perform expensive and time consuming conduit cleaning.

In another aspect, the present invention continuously reduces turbulent friction that reduces the amount of horse power needed to pump the crude oil, increases the amount of fluid able to flow in a conduit within a given amount of power while consistently repairing itself and retaining its efficacy upon degradation, providing longer and farther reaching benefits to reduce system drag than current industry standard polymers. In another aspect, the present invention liquefies paraffin and heavy asphaltenes build up, delivering friction modifiers that bond to and coat the actual surfaces of the conduit to provide sustained drag reduction without adversely impacting downstream system equipment or operations.

In another aspect, the present invention provides drag reducing compositions that require fewer injection points from the current industry standard polymers, eliminate common concerns of use with traditional drag reduction agents of foam, and temperature troubles. In another aspect, the present invention eliminates the need for multiple injection sites along with their requisite specialized injection equipment. The present invention not only requires less injection points along the conduit than polymer drag reduction agents but also fewer specialized pumps to inject the drag reducing agent.

The reduction of injection points correlates with a reduction in the amount of drag reduction agent necessary to reach positive results and eliminates the need to remove the drag reduction agent from the flowing hydrocarbon after injection; all of which provide a substantial cost reduction by use of the present invention surfactant based drag reduction agent in comparison the current industry standard polymer agent. The present invention solves the long-standing problems associated with using polymer drag reduction agents.

These and further features and advantages of the present invention will be clear from the following detailed description.

### DESCRIPTION OF THE DRAWINGS

These and other features, aspects and advantages of the present invention will become better understood with regard to the following description, appended claims, and accompanying drawings where:

FIG. 1. is a graph of flow rate against time that shows that such increase continued during line fill of the surfactant drag reduction agent of the present invention then the flow rate leveled off producing a steady state condition representing a 66.4% flow increase.

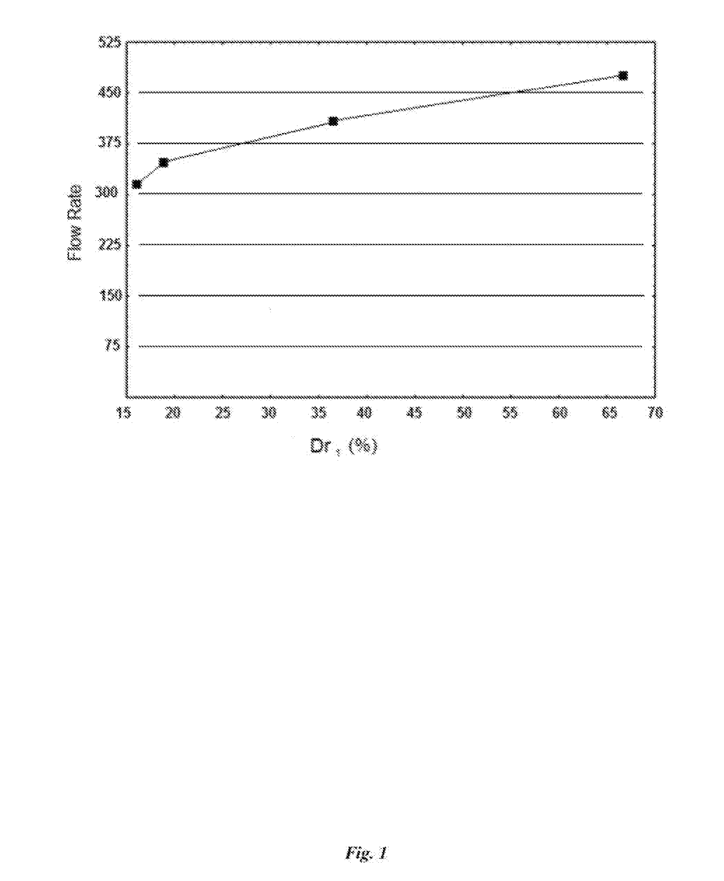

FIG. 2. is a graph of flow rate against parts per million drag reduction agent concentration that shows an increased relationship between increased parts per million concentration and flow increase.

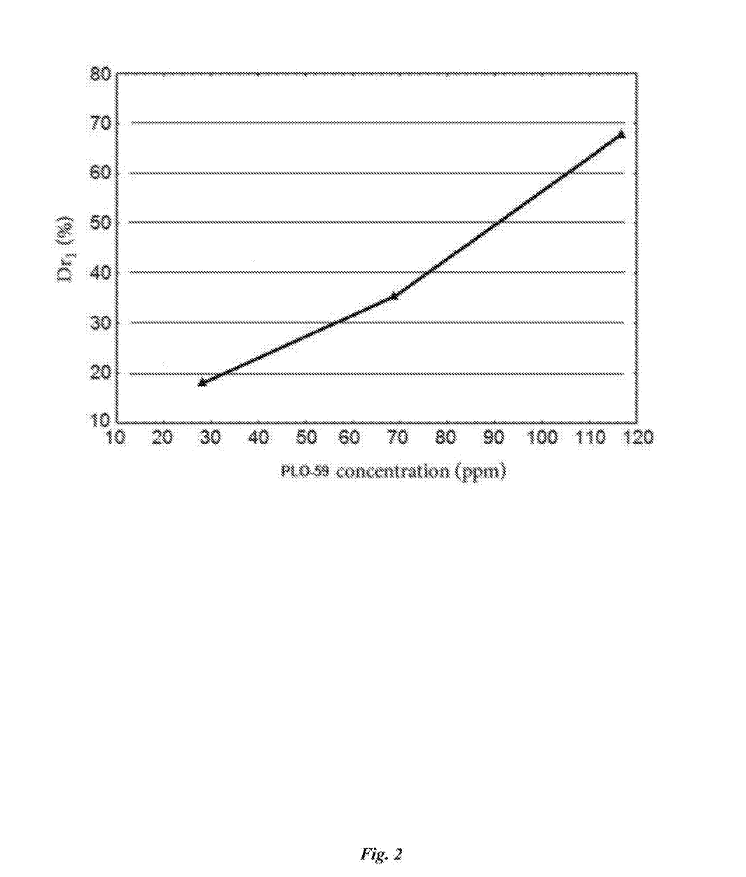

### DESCRIPTION

### Definitions

“Hydrocarbon” is an organic composition exclusively including carbon and hydrogen elements.
“HLB” (Hydrophile-Lipophile Balance) is an empirical expression for the relationship of the hydrophilic and hydrophobic groups of a surfactant.
“Paraffin” is a class of aliphatic hydrocarbons exhibiting a straight or branched carbon chain.
“Surfactant” is any composition that reduces interfacial tension between two liquids or a liquid and a solid. Also known as a surface-active agent.
“Solvent” is the component of a solution that used to dissolve other chemicals.

### Overview

In a non-limiting illustrative example, a method is disclosed for treating paraffin deposits and reducing drag in a flowing hydrocarbon, where in the deposit comprises a hydrophobic portion and an inorganic portion, the method including but not limited to contacting the deposit with a treating material to form a treated deposit, the treating material comprising a solvent blend and a surfactant.

In another non-limiting illustrative example, a method is disclosed for treating oil and gas infrastructure, wherein the infrastructure developed a deposit, the deposit including but not limited to a hydrophobic portion and an inorganic portion, the method including but limited to contacting the deposit with a treating material to form a treated deposit, the treating material including but not limited to a solvent blend, and a surfactant.

In another particular non limiting illustrative example a product is disclosed including but not limited to a tank having a deposit therein; and a treating material, wherein the treating material includes but is not limited to a solvent blend and a surfactant. In another particular non limiting illustrative example a product is disclosed, the product including but not limited to a pipe having a deposit therein and a treating material, wherein the treating material includes but is not limited to a solvent blend and a surfactant.

In another particular non limiting illustrative example of the pipe product, the deposit further comprises a hydrophobic portion and an inorganic portion and wherein the deposit is in contact with the pipe, and the treating material is in contact with the deposit. In another particular non limiting illustrative example a product is disclosed, the product including but not limited to a conduit having a deposit therein and a treating material, wherein the treating material includes but is not limited to a solvent blend and a surfactant.

The components used in the present invention offer several distinct features and advantages to the current industry standard polymer based drag reducing agents. The surfactant based drag reducing agent in the present invention is a molecule that is shear stable and promotes the formation of a stable oil water emulsion, which is beneficial to pipeline transportation. The surfactant forms rod like micelles in aqueous solutions which align in the direction of the flow and build the so-called shear-induces state. This shear stable molecule significantly reduces pressure loss and lowers the amount of horse power needed to pump the crude oil. In the event the present invention's molecule is sheared; it repairs itself within seconds. This ability to repair itself maintains an effective drag reduction agent from injection site to sites downstream from the injection site reducing the needed number of injection points.

Contrast the present invention with polymer drag reduction agents that render themselves ineffective downstream. Polymers require additional injection points in order to maintain efficacy while surfactants do not require any additional injection points to maintain efficacy. Polymer agents require multiple injection points because as the polymer flows downstream, the efficacy of the agent is reduced. Thus, to maintain efficacy, multiple inject multiple locations on conduit are necessary when using polymer drag reduction agents. Multiple injection sites needed for polymer agents also require multiple injection pumps. The increased injection site along with increased specialized pump equipment are costly additions to using polymers. Along the same lines, the reduction of additional injection points required also reduces the amount of drag reduction agent needed to be injected. The surfactant agent used in the present invention requires fewer injection points as it is shear stable that allows the agent to maintain efficacy downstream in the flowing hydrocarbon, fewer pumps to inject the drag reducing agent, and less drag reduction agent as a whole because the surfactant drag reduction agent maintains efficacy as it flows in the conduit, therefore, reducing the overall amount of drag reduction agent needed.

As previously outlined, it is generally believed in the petroleum industry that surfactants must be blended with polymeric drag reducing agents to be effective. Surfactants are also generally believed to be cost prohibitive in comparison with the commonly used polymer drag reducing agents perhaps because the belief that the surfactant must be mixed with a polymer to be effective. The surfactant used in the present invention was not mixed in any manner with a polymeric drag reducing agent but with a solvent and proves to be more effective than the industry standard polymer drag reduction agent.

The present invention's component mixture exhibited exceptional drag reducing capacities without the addition of any polymeric drag reducing agents and additionally showed an added feature of cleaning effects of waxy deposits. The industry standard polymers currently used in the marketplace only reduce drag and do not address the paraffin deposits in any measurable improvement. The present invention solves friction, flow, and wax deposit problems at a reduced cost compared to the current polymeric agents on the market that only address drag. Additionally, the present invention's component mixture comprises a much lower freezing point than polymer drag reducing agents there by significantly outperforming polymers where temperature is a factor that must be addressed.

Wax deposits collect during storage of the crude oil in both storage tanks and hydrocarbon in the conduit. These deposits severely affect the pipeline throughput. These deposits must be periodically removed from the tanks and conduit by costly pigging operations or by injecting cleaning solutions into the flowing hydrocarbon.

Surfactants can absorb onto pipe surfaces and decrease the adhesion of waxes, including specifically paraffin, to surfaces. This decreased adhesion allows the flowing mixture of the present invention to clean the pipeline surface. As the solution flows through the conduit, it increases the pipelines throughput while reducing drag at the same time. The present invention comprises a surfactant based drag reducing agent along with a paraffin dispersant that liquefies paraffin buildup on the infrastructure of the conduit. The hydrocarbon surfactant combination is obtained by blending two different solvents together and injecting the solvent blend with a surfactant additive.

The present invention is the combination of a hydrocarbon surfactant based drag reduction agent blended with solvent that not only exhibits excellent drag reduction capabilities but also liquefies paraffin. Two different solvents that are similar types of hydrocarbons are blended together and pumped with a centrifugal pump out of the holding tank into the output flow stream. The flow stream is then redirected back into the same holding tank where the solvents were blended together initially. This process is a satisfactory amount of blending to ensure no separation occurs between the two solvents and no certain temperature is required to make the solvents blend together as they are similar types of hydrocarbons. Eliminating the need to beat the solvents to a certain temperatures to obtain a preferred blend is a cost saving advantage over other mixtures that require heating to harmoniously combine. Any of several well-known methods for blending two solvents may be employed.

Solvents used in preparing the drag reducing compositions of the present invention are generally classified as any of several isomeric alkanes mixed with a liquid aromatic hydrocarbon. In a non-limiting illustrative example, Heptane and Toluene are suitable solvents to use in the solvent mixture. Any of several well-known methods of harmoniously combining may be employed as previous described.

After the solvent blend is sufficiently harmoniously combined, the surfactant additive is then injected into the solvent blend in the holding tank. Once again the centrifugal pump pushes the mixture out of the holding tank and into the output flow stream. The flow stream is then redirected back into the same holding tank where the hydrocarbons were blended together initially. This process is a satisfactory amount of blending to ensure no separation occurs between the solvents and the surfactant. No certain temperature is required to make the solvents blend together with the surfactant. Eliminating the need to heat the mixture to a certain temperatures to obtain a preferred blend is a cost saving advantage over other mixtures that require heating to harmoniously combine. Any of several well-known methods for blending may be employed.

The surface-active agent which is used in preparing the drag reducing compositions of the present invention is over-all one of high molecular weight surfactant or a mixture of surfactants. Real drag reduction in a flowing stream of hydrocarbon is dependent on the molecular weight. As a whole, the effectiveness of the surface-active agent increases as the molecular weight increases. The average molecular weight of the surfactant used in the processes and compositions of the present invention has a Hydrophile-Lipophile Balance rating of 40. Largely, suitable surfactants in the present invention can be characterized as high molecular weight surfactants. An example of a non-limiting illustration of a surfactant mixture of the present invention comprises Ethyl Alcohol, Alcohol Ethoxysulfate, Alcohol Sulfate, Amines, C10-16 aklyldimethyl, and N-oxides.

In general, the drag reducing compounds of the present invention will contain from approximately 10% by volume up to approximately 20% volume amount of surfactant additive. Unless otherwise indicated, all percentages herein are by volume of the drag reducing compositions.

Drag reduction, as defined by Savins, is the increase in pump ability of a fluid caused by the addition of small amounts of an additive to the fluid. The effectiveness of a drag reducer is normally expressed in terms of percent drag reduction. At a given flow rate, percent drag reduction is defined as:

$$D . R . = \frac{Δ Po - Δ Pp}{Δ Pp} \times 100.$$

Δpo is the base frictional pressure drop of the untreated fluid. Pp is the frictional pressure drop of the fluid containing drag reduction agent.

Percent drag reduction is a measure of drag reducing additive performance, but it does not reflect the primary end use of drag reducers. Normally, the reduced frictional pressure drop is used to increase flow rate without exceeding the safe pressure limits within the pipeline system. The relationship between percent drag reduction and percent flow increase can be estimated using the following equation:

$$\% Flow increase = [ ( \frac{1}{1 - {( \frac{\% D . R .}{100} )}^{.556}} ) - 1 ] \times 100$$

Where % D.R. is the percent drag reduction as defined in the first equation. The % flow increase equation assumes that frictional pressure drop is proportional to flow rate raised to the 1.8 power, for both treated and untreated fluids, and that the discharge pressure is constant for both the baseline and increased flow rates.

Drag reduction occurs by the interactions between elastic macromolecules and turbulent flow macrostructures. In turbulent pipe flow, the region near the walls comprising a viscous sub layer and a buffer layer plays a major role in drag reduction.

In a non-limiting example, the present invention exhibited excellent drag reduction properties and flow increase which was determined by a crude oil pipeline test on the Campeche Bay offshore Mexico. A main pipeline was selected to conduct the trial. The following will show by a non-limiting example, an embodiment setting forth the best mode of carrying out the invention.

The purpose of this test was to demonstrate the present invention's results in reducing the frictional pressure loss on a pipeline system. To examine the effectiveness of the injected drag reducer, it is first necessary to determine the baseline conditions including the pressure and flow rates experienced on the line when no additive is injected. It is also necessary to have a complete line filled with the crude oil and to collect data for at least a couple of hours to reflect normal static conditions. After obtaining steadily consistent data in normal static conditions, the present invention is injected. Pressure and flow rates data are monitored during line fill and comparisons are made between line fill conditions with and without the present invention injection.

Normal operating conditions during the pumping of Crude Oil in the main pipeline were monitored for two days. Discharge pressure at the upstream pipeline start line, midstream flow rates, and the crude oil arrival at the downstream marker were monitored and logged. After analysis and discussion, the baseline flow rate was determined to be 328 m3/hr. This was achieved with a pressure difference of 44.8 kg/cm2 between injection and arrival.

Injection of the present invention started at 12:00 AM on the first day at a predetermined rate until line fill was completed. Line fill is the moment at which the treated crude oil has displaced all the untreated crude oil from the pipeline sections. With baseline data collection, pressure and flow rates are monitored every hour until line fill is completed and the data has stabilized.

Within an hour of injecting the present invention directly into the conduit, the flow rate increased steadily. Drag reduction of 43.5% was achieved at a dosage of 118 ppm, with approximately 11.8 US gallons of the present invention per hour. Results are shown in the table below:

| Fluid Treated | Crude Oil |
|---|---|
| Baseline Flow Rate | 328 |
| Achieved Flow Rate | 471 |
| Flow Rate Increase % | 43.5% |
| Drag Reduction % | 66.4% |
| DRA Dosage, ppm | 118 |

The conduit showed a significant and demonstrable flow increase during a short period of time after the present invention was injected. The conduit used had a length of 370 km with a diameter of 42″. It was not necessary to wait until a line fill before improvements were clearly shown. The present invention could therefore be used simply to speed up the transfer of oils from one location to the other or, equally important, it could be used to maintain flow rates at a lower pressure difference. This is of significance if there are main oil line pump failures or if part of the pipeline has to be pressure down rated for any reason. Significant energy savings can also be made using the present invention. The speed of pumps can be reduced to bring down operating costs.

The conduit also showed a significant increase in flow as the present invention was added. The chart below shows the flow increase in relation to the present invention drag reducing composition. The flow increase in the conduit as the drag reducing agent concentration increased.

| Flow Increase % | Present Invention Concentration (PPM) |
|---|---|
| 11-19% | 28 ppm |
| 24-36% | 66 ppm |
| 41-66% | 118 ppm |

Implementation of the current invention consistently alters the properties of the conduit and fluid properties of the crude oil flowing in the conduit.

### How the Invention is Used

The current invention is used to improve flow efficiency and reduce costs by providing fluids with consistent properties as opposed to reactive additions of molecules that shear easily and lose the ability to reduce turbulent flow. Correct use and implementation of the present invention allow fluids to maintain a consistent stable micelle formation and properties prescribed which disrupt turbulent flow conditions and allow for improved flow while simultaneously cleaning the paraffin wax deposit build up. Correct use and implementation of the present invention also allows fewer pipeline injection points, fewer specialized pumps to inject the drag reducing agent, fewer specialized pumps to move the flowing hydrocarbon downstream, less drag reduction agent needed compared to polymer drag reduction agent, and lower amount of horse power to pump crude oil. The formula of surfactant to solvent ratio can be modified and adjusted to meet the demands of a particular pipeline or a particular crude oil. Various embodiments of the invention may implement different testing means, control equipment, means of calculation, and administration.

The invention may be used for any pipeline, storage tank, conduit, railcar, or oil tanker crude transfer system to help remove heavy deposits and restrictions while improving flow characteristics. Varied solvent and surfactant ratios may be selected by the fluids engineer based on drilling conditions. In addition, the number and frequency of measurement and iterations can be selected as necessary. The process will also be performed at predefined event conditions, such as a preselected level of pressure or flow requiring maintenance to remove and control paraffin and heavy hydrocarbon buildup in the system.

In practice, the proper volume of the present invention are accurately administered at the same time. Target pressure reduction and flow increase can be generated daily (or as scheduled) and can be tracked in real time for planning purposes. In addition, a detailed treatment sheet (which can be calculated using software) can be provided to administering rig-personnel to remove human error.

The current invention may implement different means for calculation and project planning. Calculation of the various relationships may be done manually by the drilling fluids engineer or by an operations manager in an office. Calculation by a computer is also contemplated by the current invention. A computer simulation may present a projected flow rate increase or pressure decrease with injection concentration. Projected flow increase at different intervals and time periods may also be simulated by computer to inform the drilling fluids engineer and operations manager of the correct rate of administration of the drag reducing agent current invention product.

The current invention may implement different means for administration of the present invention. It is contemplated by the current invention that the use of hoses, pumping equipment, meters, or other mechanical means may administer product according to the relationships of the current invention. Therefore, the spirit and scope of the appended claims should not be limited to the descriptions of the preferred versions herein.

Any element in a claim that does not explicitly state “means for” performing a specified function, or “step for” performing a specific function, is not to be interpreted as a “means” or “step” clause as specified in 35 U.S.C. § 112, ¶6. In particular, the use of “step of” in the claims herein is not intended to invoke the provisions of 35 U.S.C. § 112, ¶6.

What is claimed is:

1. An aqueous drag reducing composition comprising:
a drag reducing agent formed from an aqueous surfactant mixture containing a high molecular weight;
a suspending aqueous medium, said suspending aqueous medium comprising a solvent mixture formed from an aromatic hydrocarbon solvent and a linear alkane hydrocarbon.

2. The composition of claim 1, wherein said drag reducing surfactant mixture is present in an amount of from about 10-20% by weight.

3. The composition of claim 1, wherein said surfactant mixture comprises Ethyl Alcohol in an amount from about 1-5% of the surfactant composition.

4. The composition of claim 1, wherein said surfactant mixture comprises Alcohol Ethoxysulfate in an amount from about 10-30% of surfactant composition.

5. The composition of claim 1, wherein said surfactant mixture comprises Alcohol Sulfate in an amount from about 10-30% of surfactant composition.

6. The composition of claim 1, wherein said surfactant mixture comprises Amines, C10-16 alkyldimethyl, N-oxides in an amount from about 1-5% of surfactant composition.

7. The composition of claim 1, wherein said solvent mixture comprises Heptane in an amount from about 50-70% of solvent composition.

8. The composition of claim 1, wherein said solvent mixture comprises Toluene in an amount from about 20-40% of solvent composition.

9. A method of reducing drag in a flowing hydrocarbon stream comprising introducing into said hydrocarbon stream an effective amount of the drag reducing composition comprising:
a drag reducing agent formed from an aqueous surfactant mixture containing a high molecular weight;
a suspending aqueous medium, said suspending aqueous medium comprising a solvent mixture formed from an aromatic hydrocarbon solvent and a linear alkane hydrocarbon.

10. The method of claim 9 where said drag reducing composition is added to said hydrocarbon stream in an amount to provide from about 2 to 120 parts of drag reducing surfactant mixture per million parts by volume of hydrocarbon fluid in said hydrocarbon stream.

11. A method of cleaning adverse deposits in a flowing hydrocarbon stream comprising:
introducing into said hydrocarbon stream an effective amount of the drag reducing composition comprising:
a drag reducing agent formed from an aqueous surfactant mixture containing a high molecular weight;
a suspending aqueous medium, said suspending aqueous medium comprising a solvent mixture formed from an aromatic hydrocarbon solvent and a linear alkane hydrocarbon.

12. The method of claim 11 wherein said drag reducing composition is added to said hydrocarbon stream in an amount to provide from about 2 to 120 parts of drag reducing surfactant mixture per million parts by volume of hydrocarbon fluid in said hydrocarbon stream.

13. The method of claim 11 wherein said adverse deposits are wax deposits.

14. The method of claim 11 wherein said adverse deposits are paraffin wax deposits.

15. A method of cleaning adverse deposits in a hydrocarbon conduit comprising: introducing into said hydrocarbon conduit an effective amount of the drag reducing composition comprising:
a drag reducing agent formed from an aqueous surfactant mixture containing a high molecular weight;
a suspending aqueous medium, said suspending aqueous medium comprising a solvent mixture formed from an aromatic hydrocarbon solvent and a linear alkane hydrocarbon.

16. The method of claim 11 wherein said drag reducing composition is added to said hydrocarbon conduit in an amount to provide from about 2 to 120 parts of drag reducing surfactant mixture per million parts by volume of hydrocarbon fluid in said hydrocarbon stream.

17. A method of cleaning adverse deposits in a hydrocarbon storage tank comprising: introducing into said hydrocarbon storage tank an effective amount of the drag reducing composition comprising:
a drag reducing agent formed from an aqueous surfactant mixture containing a high molecular weight;
a suspending aqueous medium, said suspending aqueous medium comprising a solvent mixture formed from an aromatic hydrocarbon solvent and a linear alkane hydrocarbon.

18. The method of claim 17 wherein said drag reducing composition is added to said hydrocarbon storage tank in an amount to provide from about 2 to 120 parts of drag reducing surfactant mixture per million parts by volume of hydrocarbon fluid in said hydrocarbon stream.
